(19) United States
(12) Patent Application Publication
(10) Pub. No.: US 2002/0197525 A1
(43) Pub. Date: Dec. 26, 2002

(54) Fuel cell, electrode for fuel cell, and manufacturing method of electrode for fuel cell

(75) Inventors: Atsushi Tomita, Chiryu-shi (JP); Hideo Yano, Nisshin-shi (JP); Hikaru Okamoto, Hekinan-shi (JP); Yoshiaki Yasui, Kariya-shi (JP); Kenji Sugiura, Toyota-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AISIN SEIKI KABUSHIKI KAISHA, Kariya-shi (JP)

(21) Appl. No.: 10/151,240

(22) Filed: May 21, 2002

(30) Foreign Application Priority Data
May 21, 2001 (JP) 2001-151429

(51) Int. Cl. H01M 4/94; H01M 8/10; H01M 4/88

(52) U.S. Cl. 429/44; 429/30; 502/101

(57) ABSTRACT

A fuel cell includes a first electrode to be used as a fuel electrode provided with a fuel gas including hydrogen, a second electrode to be used as an oxidant electrode provided with a oxidizing gas including oxygen, and a solid polymer electrolyte membrane held between the first electrode and the second electrode. In the fuel cell, either the first electrode or the second electrode is formed by a gas diffusion layer compressed in the thickness direction of the gas diffusion layer in a pressing process.

This application is based on and claims priority under 35 U.S.C. §119 with respect to Japanese Patent Applications No. 2001-151429 filed on May 21, 2001 the entire content of which is incorporated herein by reference.

### FIELD OF THE INVENTION

This invention relates to a fuel cell, an electrode for the fuel cell and a manufacturing method of the electrode for the fuel cell.

### BACKGROUND OF THE INVENTION

A schematic view of a solid polymer electrolyte membrane fuel cell is shown in FIG. 1. The solid polymer electrolyte membrane fuel cell has an electrolyte membrane 3 as an electrolyte as shown in FIG. 1. The solid polymer electrolyte membrane fuel cell has catalyst layers 2 and 4 sandwiching the electrolyte membrane 3. The solid polymer membrane fuel cell further has gas diffusion layers 1 and 5 on the outside surfaces of the catalyst layers 2 and 4. The gas diffusion layers 1 and 5, in which a gas can be diffused, can collect electric currents. The gas diffusion layer 1 is a member forming an oxidant electrode. The gas diffusion layer 5 is a member forming a fuel electrode.

In the fuel electrode with which hydrogen gas or gas including hydrogen gas is provided, the following electrochemical reaction occurs.

2H₂→4H⁺+4e⁻ (1)

Proton H⁺ generated in the fuel electrode passes through the electrolyte membrane 3 and moves toward the catalyst layer 2. Electron e⁻ generated in the fuel electrode moves toward the oxidant electrode through a resistance which is electrically connected with both the fuel electrode and the oxidant electrode by conductive wires. In the oxidant electrode with which oxygen or air including oxygen is provided, oxygen is deoxidized or reduced in the following electrochemical reaction. The reduced oxygen is bound with proton H⁺, which is moved from the fuel electrode, to be water.

O₂+4H⁺4e⁻→2H₂O (2)

A part of the water generated in the above electrochemical reaction is evaporated and eliminated with the remaining oxidizer gas which is not used in the above reaction. A part of the remaining water is reversibly diffused in the electrolyte membrane 3 because of concentration gradient, then the part of water is moved toward the fuel electrode. The above electrochemical reactions (1) and (2) occur in a boundary face that the catalyst, the electrolyte and the gas contact each other.

As described above, the gas diffusion layer can collect the electric current. Furthermore, in the gas diffusion layers 1 and 5, gas can be diffused. As members forming the electrodes of the fuel cell, the gas diffusion layers 1 and 5 need to have following actions; permitting gas diffusion, moisturizing the electrolyte membrane 3, moisturizing the catalyst layers , and 4. The gas diffusion layers 1 and 5 further need to have a high electric conductivity, thermal and chemical stability, mechanical strength for protecting the catalyst layers 2 and 4, the electrolyte membrane 3, and so on.

Among the above action asked for the gas diffusion layers 1 and 5, in order to control gas diffusibility and water managements for the electrolyte membrane 3 and the catalyst layers 2 and 4, it is important to control the permeability of the gas diffusion layers 1 and 5. To obtain the high output voltage from the fuel cell, the gases must be sufficiently provided with the boundary face. The high permeability of the gas diffusion layers 1 and 5 brings the sufficient gas provision to the boundary face. The high permeability further effectively works the water to be discharged from the electrodes, thus the high permeability prevents the water from shielding the electrode.

If the permeability of the gas diffusion layers 1 and 5 are excessively high, each electrolyte included in the electrolyte membrane 3 and the catalyst layers 2 and 4 is dried out, then each water content of the electrolyte is reduced. Therefore, proton conductivity of the electrolyte membrane 3 is reduced, the output voltage of the fuel cell with the electrolyte membrane 3 is reduced, too. Generally, moistening the gases passing through the gas diffusion layers prevents the electrolyte membrane 3 and the catalyst layers 2 and 4 from being dried out. But excessive moistening brings concentration of the water, then fine pores adjacent the catalyst layers, which works as gas channels, are shield by the concentrated water. (In other words, the catalyst layers is soaked in water) The excessive moistening further brings that the water vapor is concentrated in the pores in the gas diffusion layers 1 and 5, then the concentrated water obstructs the pores in the gas diffusion layers. The excessive moistening for the gas brings a large load to the entire system of the fuel cell, therefore the power generation efficiency of the system is reduced. On the other hand, if the permeability of the gas diffusion layers 1 and 5 is too low and if the moisture is small quantity or zero, the catalyst layers 2 and 4 are soaked in the water generated by the reaction (2), the water further tends to obstruct the pores in the gas diffusion layers 1 and 5. Therefore, it is required to keep the permeability in balance in viewpoint of the water managements for the electrolyte membrane 3 and the catalyst layers 2 and 4.

As described above, the permeability of the gas diffusion layers 1 and 5 is very important property from the aspect of the water management for an electrolyte membrane and an electrode assembly (MEA).

There are various fuel cells corresponding to various operating conditions depending on their purpose of use, then the properties of the fuel cells are different as shown in following samples.

### Sample 1: Movable fuel cell for vehicle

A movable fuel cell for a vehicle is required to generate a high electric current under high gas pressure. The movable fuel cell needs a high reactivity. In addition, a flooding as a moistening phenomenon tends to occur. For improving elimination of water, gas diffusion layers 1 and 5 need to have the high permeability.

### Sample 2: Stationary fuel cell

A stationary fuel cell is required to generate the high output voltage in low electric current range and at low gas pressure from the aspect of efficiency required to this system. In the stationary fuel cell, the electrolyte membrane,e 3 tends. to be dried, thus the permeability of the gas diffusion layers 1 and 5 needs to be low.

The properties of the gas diffusion layers 1 and 5 are different depending on the material of the electrolyte membrane 3, gas passage pattern formed in a separator, and so on. It is used to be required to establish a method for easily and inexpensively determining a preferable property of the gas diffusion layers 1 and 5 corresponding to the operating condition, material forming the electrolyte membrane, the shape of the separator, and so on. A prior art for manufacturing the gas diffusion layers 1 and 5 will be described as follows. In the prior art, carbon black and water repellent (Poly TetraFluoro Ethylene PTFIE, etc.) and a disperse medium are mixed to form a paste. The paste is impregnated or printed on a predetermined substrate (a carbon paper, a carbon cloth, or something water-repellent finished with PTFE, etc.), then the resulting substrate is heated or baked. In the prior art for manufacturing the gas diffusion layers 1 and 5, the property of the gas diff-diffusion layers 1 and 5 are determined based on a void content of the substrate, quantities of the paste used for impregnation or print water repellent content in the paste, and so on. The property of the gas diffusion layers 1 and 5 are concerned a complex aggregation-dispersion mechanism varying depending on the kind of the material, components of the material, mixing method of the paste, and so on. It is difficult to control the property of the gas diffusion layers 1 and 5 as a designer intends. If the property was controlled as the designer intended, range of the controlled property would be limited by the aspects of the substrate or the paste.

### SUMMARY OF THE INVENTION

In consideration of the above problems, it is an object of the present invention to provide a fuel cell, an electrode for the fuel cell, and a method for manufacturing the electrode, which the permeability of the gas diffusion layers can be controlled and the gas diffusion layers have properties just as the designer intends.

In accordance with a first aspect of the present invention, a fuel cell has a first electrode as a fuel electrode provided with gas including hydrogen, a second electrode as an oxidant electrode provided with gas including oxygen, and a solid polymer electrolyte membrane sandwiched by the first electrode and the second electrode. In the fuel cell, at least one of the above electrodes has a gas diffusion layer compressed in thickness direction of the gas diffusion layer in a pressing process.

In accordance with a second aspect of the present invention, an electrode of the present invention is for forming any one of the fuel electrode and the oxide electrode of the fuel cell. The electrode is formed by a gas diffusion layer compressed in its thickness direction in a press processing.

In accordance with the third aspect of the present invention, the permeability of the gas diffusion layer not compressed is determined to be higher than a target permeability. The manufacturing method of the electrode for the fuel cell includes a process that the gas diffusion layer is compressed in its thickness direction by a pressing means as far as the permeability of the gas diffusion layer is reduced to the target permeability. By the fuel cell, the electrode for the fuel cell and the manufacturing method of the electrode for the fuel cell provided by the present invention, the gas diffusion layer is pressed in its thickness direction in the pressing process, then the permeability of the gas diffusion layer can be preferably controlled corresponding to a specification or the operating condition of the fuel cell. For example, if the flooding tends to occur, the gas diffusion layer needs to have the high permeability for sufficiently eliminating the water. In this case, pressing degree is reduced the density to be low level, thus the permeability of the gas diffusion layer can be higher. If the electrolyte membrane tends to be dried, the high permeability of the gas diffusion layer is not required. In this case, pressing degree is determined to be high, thus the permeability of the gas diffusion layer is reduced to lower level.

### BRIEF DESCRIPTION OF THE DRAWING

The foregoing and additional features and characteristics of the present invention will become more apparent from the following detailed description considered with reference to accompanying drawings in which like reference numerals designate like elements and wherein:

FIG. 1 shows a schematic drawing of a fuel cell of the present invention;

FIG. 2 shows a schematic drawing of a pressing process for a gas diffusion layer employing an elevating pressing machine;

FIG. 3 shows a schematic drawing of the other pressing process for the gas diffusion layer employing a rolling pressing machine;

FIG. 4 shows a diagram indicating a relation of cell temperatures and output voltages between an MES of a first example and an MES of a reference sample.

### DETAILED DESCRIPTION OF THE INVENTION

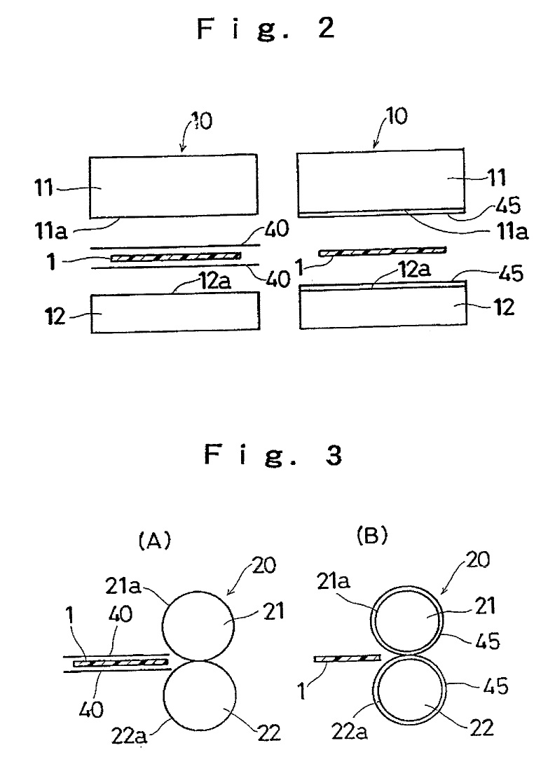

In the present invention, a gas diffusion layer is pressed in a pressing process. The gas diffusion layer before the pressing process is determined to have a higher permeability than a target permeability. In the pressing process shown in FIG. 2(A) and FIG. 2(B), an elevating pressing machine can be employed as a pressing means. As shown in FIG. 2(A) and FIG. 2(B), a press dies set 10 has a first die 11 as an upper die elevated by a driving source (not shown) and a second die 12 as a lower die. A gas diffusion layer 1 is set between pressing faces 11a and 12a and held in the first die 11 and the second die 12. The gas diffusion layer 1 is compressed in its thickness direction with the flat pressing face 11a of the first die 11 and the pressing face 12a of the second die 12. A mold release sheet 40 as a mold release agent shown in FIG. 2(A) is sandwiched between the gas diffusion layer L, the first die 11 and the second die 12. A mold release layer 45 in FIG. 2(B) is overlapped on the pressing face 11a of the first die 11 and the pressing face 12a of the second die 12. A pressing machine having the press die set 10 may be driven by hydraulic pressure or mechanical pressure. In a hot pressing by the above pressing A machine, either the first die 11 or the second die 12 or both has a heater. In the pressing process shown in FIG. 3(A) and FIG. 3(B), a rolling pressing machine can be employed as a pressing means. A press die set 20 has a first rolling die 21 as the upper die and a second rolling die 22 as the lower die. Rolling the first rolling die 21 and the second rolling die 22 around their rotational shafts, the gas diffusion layer 1 is inserted between the first rolling die 21 and the second rolling die 22, then the gas diffusion layer 1 is compressed in its thickness direction with a pressing face 21a of the first rolling die 21 and a pressing face 22a of the second rolling die 22. there is a gap between the pressing face 21a of the first rolling die 21 and the pressing face 22a of the second rolling die 22, then a pressing force can, be controlled by adjusting the gap. The mold release sheet 40 shown in FIG. 3(A) is sandwiched between, the gas diffusion layer 1, the first rolling die 21, and the second rolling die 22. The mold release layer 45 in FIG. 3(B) is overlapped on the pressing face 21a of the first die 21 and the pressing face 22a of the second die 22.

The mold release sheet 40 and the mold release layer 45 prevent the gas diffusion layer 1 from adhering to the first die 11 or the second die 12, and prevent the gas diffusion layer 1 from the first rolling die 21 or the second rolling die 22 even if the pressing force is excessively large or the heating temperature in the pressing process is high. The mold release sheet 40 and the mold release layer 45 are made of non-adhesive resin (polyimide resin, polyamide resin, fulorocarbon resin, silicone resin, etc). In the hot pressing is by the above pressing machine, either the first rolling die 21 or the second die 22 or both has the heater.

When the gas diffusion layer 1, separator, etc. are overlapped each other in their thickness direction in the fuel cell, the surface pressure per unit area applied to the gas diffusion layer is assumed to be F1, and when the pressing force per unit area when the gas diffusion layer is pressed is assumed to be F2, creep resistance of the gas diffusion layer is effective as far as F2 is larger than F1.

In accordance with the present invention, the gas diffusion layer may be compressed by a cold pressing, but it is preferable that the gas diffusion layer is compressed in the hot pressing. The gas diffusion layer can be also compressed in the cold pressing. If the gas diffusion layer includes carbon fiber, carbon black, resin as binder (for example, PTFE), the gas diffusion layer becomes hard, then the cold pressing needs additional pressing force if the gas diffusion layer. In the cold pressing, the carbon fiber is hard to slide in the binder in the gas diffusion layer. All these thing makes it clear that the carbon fiber as the substrate of the gas diffusion layer tend to fracture in the cold pressing, then tensile strength of the gas diffusion layer may be reduced. In the cold pressing, the binder in the gas diffusion layer is kept to be hard, the binder itself tends to fracture, it may be a reason for the gas diffusion layer to fracture. Therefore, it is preferable to employ the hot pressing for heating the gas diffusion layer. The temperature to heat the pressing dice can be preferably determined to be from 100 to 350° C., especially 200 to 300° C.

In accordance with the present invention, the gas diffusion layer before the pressing process includes the carbon fiber as substrate fiber having conductivity, graphite powder, and binder for binding the substrate fiber and the graphite powder. As the gas diffusion layer is compressed, the,e orientation of the carbon fiber is heightened, then the substrate fiber is easy to contact with each other. Flaky crystal graphite powder as the graphite powder can be employed, and the flaky crystal graphite powder having large aspect ratio (the ration of diameter to thickness) can be preferably employed. Either 2 to 250 or 3 to 100 are taken for example, but the aspect ratio needs not to be limited as the above ratio. If the graphite powder, especially the flaky crystal graphite powder is included in the gas diffusion layer, the contact areas between the graphite fiber are enlarged because the graphite fiber contact each other by the way of the particle of the graphite powder, then the conductivity of the substrate fiber is heightened. Furthermore, if the gas diffusion layer including the flaky crystal graphite powder is pressed, the conductivity of the substrate is further heightened. Therefore, the electric current collecting performance of the gas diffusion layer constructing of the electrode is heightened. Of course, the graphite powder except the flaky crystal graphite powder can be used.

In accordance with the present invention, the gas diffusion layer before pressed is manufactured by the following processes: a first process for preparing a first liquid material including the carbon fiber etc as the substrate fiber, the graphite powder and the binder, a wet paper-making process for the first liquid material to be formed into a sheet, and a cutting process for cutting the sheet in a required size. Water as a dispersion medium is preferably employed in the above processes. Toluene, xylene, cyclohexane, etc. as organic solvents may be employed. The first liquid material may include organic dispersion material which is dispersed in the first process, and other organic binder. In the wet paper-making process, the first liquid material is separated to solid material and the dispersion medium, then the solid material is agglutinated to form the sheet like a paper. The first liquid material is strained or filtered by a filtering member with a net for the first liquid material to the solid material and the dispersion medium, then the solid material remaining on the net is formed to be a thin sheet. The binder included in the first liquid material is desired to be a burnable binder which can be burned out. As the burnable binder, fiber of wood pulp as organic material can be taken for example. The vegetable fiber like cotton, etc. or animal fiber like wool, etc. also may be employed in some case. In the first liquid material, if the content of the substrate fiber and the burnable binder is assumed to be 100 by weight, the content of the graphite powder is desired to be 0.5 to 60 by weight.

After the wet paper-making process, the gas diffusion layer before pressed is treated in the following processes: an impregnating process which a second liquid material including water-repellent binder as main is contacted with the sheet manufactured in the wet paper-making process, the burnable binder is impregnated in pores in the sheet, and an eliminating process which the burnable binder as wood pulp, etc. is burned to be eliminated in parallel with fixing the binder having water-repellency with the sheet through heating. The binder is more burnable than the substrate fiber as the carbon fiber, etc. having conductivity and the flaky crystal graphite powder, then the substrate fiber and the graphite powder are kept in the gas diffision layer after eliminating process. As the burnable binder, organic material like the fiber of wood pulp, etc. as the vegetable fiber and the wool, etc. as animal fiber can be employed. The burnable binder is burned out, then pores are generated from that, thus the gas diffusion layer is heightened in using the fuel cell, the binder having water-repellency can be sufficiently impregnated. Fluorocarbon resin is preferably employed as the binder having the water-repellency. Poly tetrafluoro Ethylene PTFE as the fluorocarbon resin is preferably employed. Copolymer of Ethylene and tetrafluoro ethylene ETFE, another copolymer of tetrafluoro ethylene and perfluoro alkyl vinyl ether PFA, another copolymer of tetrafluoro ethylene and hexafluoro propylene, etc can be employed. In the abovementioned impregnating process, suspension in which particles of the fluorocarbon resin are dispersed can be employed as the second liquid material. It is preferable for the above second liquid material to include carbon black as conductive material formed by microparticles. By the use of the conductive material, the conductivity of the electrode is further heightened. In the present invention, it is not necessary for the gas diffusion layer to include the carbon black. In addition, if the gas diffusion layer includes the carbon black, the carbon may be employed except flaky crystal graphite. The electrode of the fuel cell may have a catalyst layer or not. If the electrode has the catalyst layer, the catalyst layer is overlapped on the electrolyte membrane at the side of the electrode. The main component of the catalyst layer may be platinum, etc. as catalyser.

### EXAMPLE

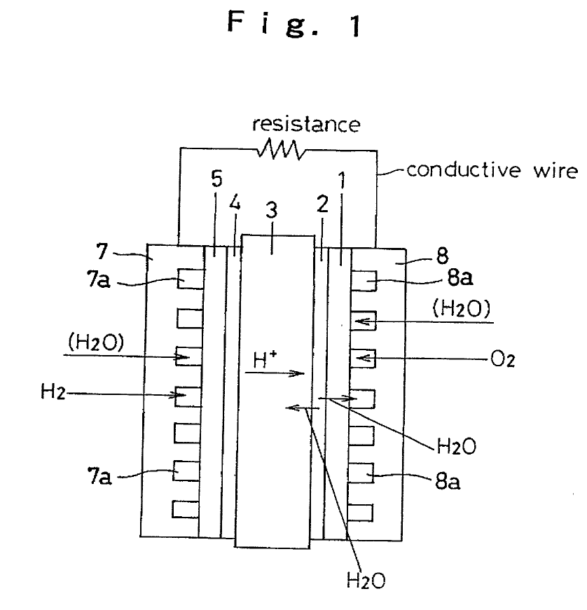

An example of the present invention will be described as follows with reference to some figures. A cell of the fuel cell shown in FIG. 1 has the gas diffusion layer 1 for forming an oxidize electrode, an electrolyte membrane 3 as a solid polymer electrolyte membrane, the gas diffusion layer 5 for forming a fuel electrode. A number of the above cell are built up for forming a stack of fuel cell. A catalyst layer 4 facing the electrolyte membrane 3 is disposed between the gas diffusion layer 5 and the electrolyte membrane 3 forming the fuel electrode. As same as the catalyst layer 4, a catalyst layer 2 supporting catalyst metal facing to the electrode 3 is disposed between the gas diffusion layer 1 and the electrolyte membrane 3.

The gas diffusion layer 5 constructing the fuel electrode of the cell faces to a passage forming member 7. The passage forming member 7 is generally called a separator having a gas passage 7a for gas including hydrogen (or pure hydrogen gas) as anode active substance passing through. The gas passage 7a is formed on the passage forming member 7.

The gas diffusion layer 1 constructing the oxide electrode of the cell faces to a passage forming member 8. The passage forming member 8 is a generally called another separator having a gas passage 8a for gas including oxygen (or pure oxygen gas) as cathode substance passing through. The gas passage 8a is formed on the passage forming member 8. To the above fuel cell, the gas including hydrogen (or pure hydrogen gas) is provided through the gas passage 7a, and the gas including oxygen (or air, etc.) is provided through the gas passage 8a.

The above gas diffusion layer 1 and 5 can be prepared as the same sort. Hereinafter, a method for manufacturing the gas diffusion layer 1 will be described.

In the example, the gas diffusion layer 1 and MEA was manufactured as following processes. The gas diffusion layer 1 was manufactured based on the art disclosed in Japanese Patent Application Publication as Toku-Kai 2000-136493 as the following wet paper-making process.

1. Carbon fiber as substrate fiber having conductivity (diameter of a piece: 12 μm, length of a piece: 3 mm) and pulp fiber 40 were prepared. The weight ratio of the carbon fiber to the pulp fiber was 60 to 40. Flaky crystal graphite of which weight ratio to the carbon fiber was 10 was added to the carbon fiber and the pulp fiber. The carbon fiber, wood pulp fiber and the flaky crystal graphite were dispersed in water as dispersion medium with a preferable dispersion agent, the mixture was formed to be a paste (the first liquid material). The average, diameter of the particle of the flaky crystal graphite was determined to be 20 μm. The average thickness of the particle was determined to be 1 μm.

2. The first liquid material was formed into a sheet in the wet paper-making process. The weight per unit area of the sheet was determined to be 50 g/m². The thickness of the sheet was determined to be 0.3 mm. In the wet paper-making process, the paste (the first liquid material) was separated to the solid material and the water, then the resulting solid material was formed to be the sheet.

3. Small particles of carbon black (average diameter of particle: 30 nm) was mixed with ion-exchanged water, and further dispersed with detergent, then other liquid material was made. Furthermore, PTFE dispersion (grade D-1, including 60 weight % of PTFE particles, manufactured by DAIKIN INDUSTRIES, LTD) is mixed with the above liquid material as that the weight ratio of the PTFE to the carbon black is 1 to 4, then ink (the second liquid material) was made. In addition, by changing the quantity of the PT-E, the property of the gas diffusion layer , can be controlled.

4. The ink made in the process 3 was impregnated with the sheet made in the process 2. The impregnated sheet was dried in the atmosphere at approximately 80° C. for an hour. Furthermore, the once dried sheet was dried out kept at 380° C. for 60 minutes. Thus, the PTFE in the ink was melted and fixed with the sheet. At that time, the wood pulp fiber included in the sheet was burned out and eliminated, then the pores, in which pieces of the wood pulp fiber had been located, were generated in the sheet. The pores can work as the gas channels and water discharging channels of the fuel cell. The gas diffusion layer was treated as the gas diffusion layer of a reference sample. The thickness of the gas diffusion layer of the reference sample was 0.31 mm.

5. The gas diffusion layer of the reference sample was compressed in the press die set 10 shown in FIG. 2(A) at 240° C. for five minutes. In the pressing, three pressing forces were determined for three examples as shown in Table 1. The gas diffusion layer of Example 1 was compressed to be 0.21 mm in thickness. The gas diffusion layer of Example 2 was compressed to be 0.20 mm in thickness. The gas diffusion layer of Example 3 was compressed to be 0.18 mm in thickness. Before the pressing, the mold release sheet was inserted between the pressing faces 11a, 12a and the gas diffusion layer 1 for preventing the gas diffusion layer from being fixes with the pressing faces 11a and 12a.

6. Carbon supporting platinum (manufactured by Johnson Matthey), polymer electrolyte membrane solution (manufactured by Asahi KASEI), and ion-exchanged water were mixed to be catalyst paste.

7. The catalyst paste was rubbed or applied on a suitable polymer film based on doctor blade method as that the platinum was dispersed on the polymer film for 0.5 mg/cm². The polymer film, on which the platinum was applied, was dried out in atmosphere for 24 hours to be catalyst film. The polymer film is used for only shaping the catalyst paste in sheets, then the polymer films is removed from the catalyst films not to exist as a member of the electrode in the fuel tell.

8. The catalyst film was cut into requisite number of circular films having 40.0 mm of diameter (12.57 cm² of area). Thus the catalyst films 2 and 4 were made.

9. The electrolyte membrane 3 (Gore Select 40 manufactured by Gore-Tex) was sandwiched between the catalyst films 2 and 4 as that the side not covered with the polymer film was in contact with each side of the electrolyte membrane 3. Then the electrolyte membrane 3 sandwiched between the catalyst films 2 and 4 were pressed in a hot pressing machine (at 160° C. under 4.0 MPa for 1.5 minutes), then the catalyst films 2 and 4 were joined with the both sides of the electrolyte membrane 3, respectively. After the joining, the polymer films on the catalyst films 2 and 4 were removed. Thus the electrolyte membrane 3 with the catalyst films 2 and 4 was obtained. Furthermore, the gas diffision layer of Reference Sample made in the above process 5 was cut into two circular gas diffusion layer having 40.0 mm of diameter (12.57 cm² of area). The above electrolyte membrane 3 with the catalyst films 2 and 4 was further sandwiched between the gas diffusion layers of Reference Sample. The electrolyte membrane 3 and the gas diffusion layers were pressed in the hot pressing machine (at 160° C. under 4.0 MPa for 1.5 minutes), then the MEA of Reference Sample was obtained. In the same processes as the MEA of Reference Sample was obtained, the MEAs of Examples 1 to 3 were obtained by using the gas diffusion layers 1 to 3, respectively.

### Evaluation of Gas Diffusion Layer

The material properties of the solo gas diffusion layer 1 before joined with the electrode membrane 3 were measured. The thickness of the gas diffusion layer 1 was measured by a micrometer. The permeability of the gas diffusion layer 1 was measured following steps: fixing the gas diffusion layer 1 in a measuring device, making the dried nitrogen gas flow to the gas diffusion layer 1 in perpendicular to the surface of the gas diffusion layer 1, and measuring differential pressure between both sides of to the gas diffusion layer 1. The resistance of the gas diffusion layer 1 was measured as that a specimen from the gas diffusion layer 1 was held between carbon plates and pressed under 1.96 MPa of pressure. The results of the measurement are shown in Table 1.

TABLE 1

| | | | Resistance |
|---|---|---|---|
| | | | (mO/cm²) |
| | Thickness | Permeability | pressurizing under |
| Gas diffusion layer | (mm) | (μm/Pa S) | 1.96 MPa |
| Gas diffusion layer of | 0.31 | 496 | 13.1 |
| Reference Sample | | | |
| Gas diffusion layer of | 0.21 | 135 | 11.0 |
| Example 1 | | | |
| Gas diffusion layer of | 0.20 | 45 | 9.9 |
| Example 2 | | | |
| Gas diffusion layer of | 0.18 | 38 | 9.5 |
| Example 3 | | | |

As seen in Table 1, if the permeability of the gas diffusion layer of Reference Sample (496 μm/Pa S) is assumed to be 100%, the permeability of the gas diffusions layer of Example 1 is 27% (135 /496×100=approximately 27%), the permeability of the gas diffusion layer of Example 2 is 9% (45/496×100=approximately 9%), and the permeability of the gas diffusion layer of Example 3 is 7.7% (38/496×100=approximately 27%). If the resistance of the gas diffusion layer of Reference Sample (13.1 m Ω/ cm2) is assumed to be 100%, the resistance of the gas diffusion layer of Example 1 is 84% (11.0/13.1×100=approximately 84%), the resistance of the gas diffusion layer of Example 2 is 76% (9.9/13.1×100=approximately 76%), and the resistance of the gas diffusion layer of Example 3 is 73% (9.5/13.1×100=approximately 73%). By pressing the gas diffusion layer 1 in its thickness direction, the gas diffusion layer 1 itself was made to be thin, the permeability of the gas diffusion layer 1 was made to be low, the resistance of the gas diffusion layer 1 was made to be low. In other words, by pressing the gas diffusion layer 1 in its thickness direction, the thickness of the gas diffusion layer 1, the permeability of the gas diffusion layer 1, and the resistance of the gas diffusion layer can be controlled.

As the thickness of the gas diffusion layer 1 of Reference Sample (0.31 mm) is assumed to be 100%, the thickness of the gas diffusion layer 1 of Example 1 is 58% (0.18 mm: calculated as 0.18/0.31×100=approximately 58%). If the thickness of the gas diffusion layer 1 was as approximately half of that before pressing, the gas diffusion layer 1 was is kept to have enough mechanical strength for using in the fuel cell.

### Evaluation of Fuel Cell

The gas diffusion layer 1 of Example 1 was attached to an actual fuel cell, the varying electric pressure relative to the cell temperature of the fuel cell was measured when the fuel cell was operated. Then, the difference between the properties of the MEA of Reference Sample and those of the MEA of Examples were measured. The gases provided to the fuel cell were humidified by passing through the water of which temperature was controlled (bubbling). The gases can be humidified by saturated vapor at the temperature of the bubbling. The operating condition of the fuel cell was determined as follows.

Electric current density: 0.74 A/cm²

Utilization ratio of gases: pure hydrogen/air=80%/15%

Gas pressure: pure hydrogen/air=0.2 MPa/0.2 MPa

Temperature of bubbling: pure hydrogen/air 90° C. /50° C.

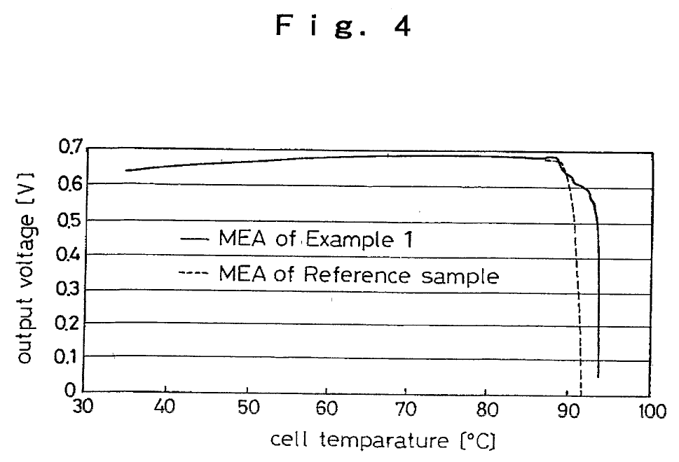

The results showing output power from the operated fuel cell are shown in FIG. 4. The higher the cell temperature become, the more the inside of the MEAs become dried out. Thus, when the cell temperature reaches approximately 90° C., the output voltages of the MEAs in accordance with both Reference Sample and Example are drastically reduced. As seen in FIG. 4, when the cell temperature is higher than about 88° C., the output voltage of the MEA of Examples are higher than that of Reference Sample.

The reason why the output voltages differ from each other between in Reference Sample and in Examples is described as follows. As against the MEA of Reference Sample, the MEAs of Examples are pressed in its thickness direction, the densities of the MEAs of Examples are higher than that of Reference Sample, thus the permeabilities of the MEAs of Examples are reduced. Therefore, water-holding capacities of the MEN, which are capacities for holding water inside, the electrolyte membrane 3, and the catalyst layers 2 and 4, are heightened. By heightening the water-holding capacities, when the electrolyte membrane 3 tends to be dried out (when the cell temperature is high), the output voltages of Us in accordance with Examples are higher than that of Reference Sample.

As described above, pressing the gas diffusion layer 1 in its thickness direction can control the permeability of the gas diffusion layer 1. If the gas diffusion layer 1 not pressed is determined to have the higher permeability compared to the target permeability, adjusting in the pressing process makes the MEAs of Examples have the target permeabilities for which a designer aims. Actually, there are many kinds of MEAS employed in the fuel cells for varying the purpose and shape of the gas passage of the separator. Accordingly, the MEAs of Examples are superior to that of Reference Sample in viewpoint of the water-holding capacity, each gas diffusion layer 1 employed in the MEAs of Examples adapts a stationary fuel cell used under the condition that the gases are provided to the fuel cell with low pressure, the gases are not sufficiently humidified, and that the electric current density is allowed to be low.

As shown by each gas diffusion layer 1 of Example 1 to 3, by a simple means of pressing the gas diffusion layer 1, the gas diffusion layer 1 which adapts various types of fuel cell can be manufactured.

Advantages of the gas diffusion layer 1 through the pressing process will be described as following (1) to (7).

(1) By pressing the gas diffusion layer 1 in its thickness direction, the gas diffusion layer 1 is compressed in its thickness direction, the permeability of the gas diffusion layer 1 can be freely and easily controlled. Thus, the water management for the MEA can be easily done answering the condition in which the fuel cell is used, the material to be used for the gas diffusion layer 1, and the shape of the separator. Especially, the gas diffusion layer 1 manufactured by the abovementioned wet paper-making process has many pores inside, because the wood pulp fiber as binder had been burned out and the pores were generated from that. As the material, for binding the carbon fiber and the carbon black as conductive material, PTFE, etc. can be chosen as soft resin, then the gas diffusion layer 1 can be compressed at various compressibility ratio.

(2) As shown in Table 1, by pressing the gas diffusion layer 1 in its thickness direction, the resistance of the gas diffusion layer 1 per unit area can be reduced. The reduction of the resistance per unit area effectively improves the electric current collecting performance of the gas diffusion layer 1. The reason of the improvement is as follows. When the gas diffusion layer 1 is compressed in its thickness direction, the carbon fiber having conductivity is oriented along the both side surfaces of the gas diffusion layer 1, it probably makes that the contacting points between pieces of carbon fiber are increased. Depending on the degree of the pressing force applied to the gas diffusion layer 1,

(3) By pressing the gas diffusion layer 1, its thickness can be controlled. The gas diffusion layer 1 can favorably contact the separator without spoiling the gas shielding performance of the gas diffusion layer 1.

(4) By pressing the gas diffusion layer 1, even if a piece of the carbon fiber protrudes from the side surface of the gas diffusion layer 1 before pressing, the piece of fiber can be repressed, thus flatness of the gas diffusion layer 1 is improved. As the flatness is improved, the surface of the electrolyte membrane 3 is less damaged by the gas diffusion layer when they are joined. In addition, each side surface of the catalyst layers 2 and 4 can further closely contact the side surfaces of the gas diffusion layer 1, contact resistance between the catalyst layers 2 and 4 and the gas diffusion layer 1 is reduced, then the output voltage of the fuel cell can be increased.

(5) Generally, when the gas diffusion layer is attached to the fuel cell, the MEA is held with pressure to overlap the other member of the fuel cell in the direction in which the fuel cells stack, thus the gas diffusion layer may strain in creep. But the gas diffusion layers 1 of Examples are compressed with high pressure, the resulting gas diffusion layers 1 less strain in creep. The pressure per unit area, which is applied to the pressurized part of the gas diffusion layer 1 when the gas diffusion layer 1 is attached to the fuel cell, is assumed to be F1. The pressure pre unit area applied to the gas diffusion layers 1 and 5 in the pressing process is assumed to be F2. When F1 is larger than F2, the gas diffusion layer 1 less strain in creep. Then the contact resistance between the gas diffusion layer, 1 and the separator is effectively kept to be low.

(6) In Examples, the catalyst paste to be the catalyst layers 2 and 4 is applied on both side surfaces of the electrolyte membrane 3, the catalyst paste may applied on even the one side surface of the gas diffusion layer opposed to the electrolyte membrane 3.

(7) In Examples, the gas diffusion layers 1 manufactured by the wet paper-making process were pressed. The above gas diffusion layer 1 has pores inside thereof because the pulp fiber, etc. which had been mixed before baking was burned out or eliminated. Furthermore, the material for binding the carbon fiber and the carbon black as conductive material includes PTFE, etc. as the soft resin. Thus, when the gas diffusion layer 1 is compressed in the pressing process, the resin included in the gas diffusion layer 1 easily extends, even the carbon fiber easily slides in the resin, thus the gas diffusion layer 1 can be compressed at the various compressibility ratio.

The present invention can be applied to another type of sheet made from carbon except the gas diffusion layer 1 manufactured by the wet paper-making process. For example, the gas diffusion layer made of carbon paper, carbon cloth, etc. may pressed. If the gas diffusion layer made of the carbon paper or carbon cloth is compressed, the gas diffusion layer should not be pressed with excessive pressure. Because the carbon paper, the carbon cloth, etc. include a little resin, and has portion the carbon fiber concentrates in their thickness direction, the carbon fiber forming the carbon paper, the carbon cloth, etc. is easily damaged or broken.

In accordance with the gas diffusion layer made of the carbon paper, the carbon paper includes the material for binding the pieces of the carbon fiber (thermosetting plastic). But the material was already carbonized by heating in its manufacturing process, thus the material securely connects the pieces of the carbon fiber forming the carbon paper. In the gas diffusion layer made of the carbon paper, the pieces of the carbon fiber are limited to slide in the material. If the gas diffusion layer 1 is heated in parallel with pressing, the material binding the pieces of the carbon fiber is not softened. If the pressing force is excessively large, the carbon fiber is easily broken in the pressing process.

On the other hand, according to the gas diffusion, layer made of the carbon, cloth, the carbon is woven with the carbon fiber running in warp and weft direction. The carbon cloth has the portions in which the warps overlap the wefts, the pieces of carbon fiber are concentrated in the thickness direction of the carbon cloth in the portion, then the portions are hard to be compressed. If the pressing force is excessively large, the carbon fiber forming the carbon cloth may be broken. It is not preferable for the excessive pressure not to be applied to the carbon cloth.

The test results indicating how the carbon paper or the carbon cloth is compressed are shown in Table 2. Substrate made of carbon paper was broken when the thickness of the carbon paper was reduced to be 69% relative to the original thickness (when the compressibility ratio reaches 31%). Substrate made of carbon cloth was broken when the thickness of the carbon paper was reduced to be 78% relative to the original thickness (when the compressibility ratio reaches 22%). It is preferable to limit the pressure in pressing process to extent at which the substrate is not broken.

TABLE 2
Compressibility Ratio upon breakage of substrate
(Ratio of thickness of compressed substrate to original thickness)
(%)

| | |
|---|---|
| Carbon Cloth Type Substrate | 69% |
| (GF-20P7, manufactured by NIPPON CARBON Co., Ltd) | |
| Carbon Paper Type Substrate | 78% |
| (TORAYCA TGP-H-060, manufactured by TORAY) | |

To the contrary, when the gas diffusion layer 1 of Examples manufactured in the wet paper-making process can be compressed as that the thickness of Example is reduced to be 58% relative to that of Reference Sample, then the compressibility ratio of the gas diffusion layer 1 reaches 42% (100−58=42). But, there is no trouble even if the thickness of the gas diffusion layer is reduced as far as the compressibility ratio reaches 42%. The gas diffusion layer 1 manufactured in the wet paper-making process has enough mechanical strength even if the gas diffusion layer is compressed to be thinner. As described above, compressing the gas diffusion layer 1 manufactured in the wet paper-making can be easier than compressing the carbon paper or the carbon cloth.

The abovementioned advantage of the gas diffusion layer 1 is applicable to the case of the gas diffusion layer 5 because the gas diffusion layer 5 is made of the same material. In addition, it is applicable that the gas diffusion layer 1 may differ from the gas diffusion layer 5 in viewpoint of material or content.

In Example, the catalyst layers 2 and 4 are transferred or fixed to the electrolyte membrane 3, then the electrolyte membrane with catalyst layer was manufactured. After that the gas diffusion layer was compressed in its thickness direction. Finally, the resulting gas diffusion layer was joined with the electrolyte membrane with catalyst layer.

But the joining method is not limited as the above, the gas diffusion layer may be joined with the separator as following processes. At first, the catalyst layers are applied on the gas diffusion layer 1. Next, the resulting gas diffusion layers 1 and 5 as the electrodes (separators) with catalyst layer are compressed in the pressing process. Finally, the resulting electrodes are joined with the electrolyte membrane.

In the manufacturing method of the present invention, by pressing the gas diffusion layer, the permeability of the gas diffusion layer forming the electrode of the fuel cell can be controlled. The manufacturing method is effective to form the gas diffusion layer having the permeability for which the designer aims. Furthermore, the resistance of the gas diffusion layer can be controlled through the pressing process, then the manufacturing method is effective in this point.

In accordance with the present invention, when the flooding tends to occur, the permeability of the gas diffusion layer needs to be heightened for eliminating water by reducing, then the permeability of the gas diffusion layer can be higher. To the contrary, when the electrolyte membrane tends to be dried out, the permeability of the gas diffusion layer does not need to if be heightened, then the permeability of the gas diffusion layer can be controlled to be lower through the pressing process with higher pressure.

If the gas diffusion layer before pressing includes the carbon fiber, etc. as the substrate fiber having conductivity, the flaky crystal graphite powder having the large aspect ratio, and the resin as the material for binding the pieces of the substrate fiber on the flaky crystal graphite powder, the compressibility ratio of the gas diffusion layer can be heightened. It is preferable to manufacture the gas diffusion layer having the permeability, etc. as the properties as the designer intended.

Before the pressing process, the gas diffusion layer manufactured in the wet paper-making process has many pores inside, because the pulp fiber as the binder which had been mixed before baking is burned out or eliminated from the gas diffusion layer. The gas diffusion layer further includes the soft resin, for example, PIFE as the material for binding the substrate fiber on the graphite powder. When the above gas diffusion layer is compressed in the pressing process, the resin can extend, and the carbon fiber, etc. as the substrate fiber can slide in the resin.

In accordance with the present invention, when the gas diffusion layer, separator etc are overlapped each other in their thickness direction in the fuel cell, the surface pressure per unit area applied to the gas diffusion layer is assumed to be F1, and when the pressing force per unit area when the gas diffusion layer is pressed is assumed to be F2, the creep resistance of the gas diffusion layer is effective as, far as F2 is larger than F1.

What is claimed is

1. A fuel cell comprising:
a first electrode to be used as a fuel electrode provided with a fuel gas including hydrogen;
a second electrode to be used as an oxidant electrode provided with a oxidizing gas including oxygen; and
a solid polymer electrolyte, membrane held between the first electrode and the second electrode,
wherein at least one of the first electrode and the second electrode is formed by a gas diffusion layer compressed in the thickness direction of the gas diffusion layer in a pressing process.

2. An electrode of a fuel cell for forming any one of a first electrode as a fuel electrode provided with hydrogen and a second electrode as an oxidant electrode provided with oxygen, wherein the electrode includes a gas diffusion layer compressed in the thickness direction of the gas diffusion layer in a pressing process.

3. The electrode of the fuel cell according to claim 2, wherein the gas diffusion layer which is not compressed in the pressing process includes a substrate fiber having conductivity and a graphite of which particle is shaped like a flake having a large aspect ratio, and a material for binding the substrate fiber on the graphite.

4. A manufacturing method of and electrode for a fuel cell including a pressing process for pressing a gas diffusion layer, which forms any one of a fuel electrode and an oxidant electrode for the fuel cell, with a pressing means for pressing in the thickness direction of the gas diffusion layer, wherein the gas diffusion layer previously has a permeability determined to be higher than a target permeability.

5. The manufacturing method of the electrode for the fuel cell according to claim 4, wherein the pressing process is a hot pressing.

6. The manufacturing method of the electrode for the fuel cell according to any one of claim 4 and claim 5, wherein a mold release material is disposed between the gas diffusion layer and a pressing face of the pressing means.
